(19) United States
(12) Patent Application Publication
(10) Pub. No.: US 2015/0281789 A1
(43) Pub. Date: Oct. 1, 2015

(54) COMMUNICATING MEDIA RELATED MESSAGES

(71) Applicant: KONINKLIJKE PHILIPS N.V., Eindhoven (NL)

(72) Inventors: Mauro Barbieri, Eindhoven (NL); Andras Kalmar, Schwechat (AT); Adolf Proidl, Vienna (AT); Johannes Henricus Maria Korst, Eindhoven (NL); Serverius Petrus Paulus Pronk, Vught (NL); Ramon Antoine Wiro Clout, Eindhoven (NL)

(21) Appl. No.: 14/439,362

(22) PCT Filed: Sep. 12, 2013
(86) PCT No.: PCT/IB2013/058484

§ 371 Date: Apr. 29, 2015

Related U.S. Application Data
(60) Provisional application No. 61/721,532, filed on Nov. 2, 2012.

(51) Int. Cl. H04N 21/4788; H04N 21/4782; H04N 21/235

(52) U.S. Cl. CPC H04N 21/4788; H04N 21/235; H04N 21/4782

(57) ABSTRACT

A system (1) comprises a media receiver (10) for receiving a broadcast signal comprising media data, a rendering device (20) for providing an audible and/or visual output from the media data, and a user equipment (30) capable of exchanging messages (M) via an internet service (40), the user equipment (30) having an media item comment option for submitting a message (MSG) about a media item. The user equipment (30) is arranged for issuing a data request signal (DRQ) to the media receiver if the user selects the media item comment option and the media receiver is arranged for providing extracted representative information (RINF) about a portion of the media item that is reproduced when or shortly before the request is received, and for providing said representative information (RINF) to the user equipment (30). The user equipment (30) is capable of including said representative information in said message (MSG) about a media item.

### FIELD OF THE INVENTION

The present invention relates to a system for communicating media related messages.

The present invention further relates to a method for communicating media related messages.

The present invention still further relates to a media receiver, a server and a user equipment for use in the system.

The present invention still further relates to a computer program product for a user equipment and for a data processing device.

### RELATED ART

Watching TV has always been a social activity for many people. Watching TV shows, soccer matches, etc. together with other persons in the same room adds to the experience. One can in real-time comment on what is shown in real time, and emotions can be shared in real time. This has always been an important aspect in the perceived attractiveness of watching TV. And, until recently, the members of a single household would typically spend quite some time on watching TV together.

With the continuous decrease of the price of TV sets over the years, we see an increase in the number of TV sets per household. Additionally, it is quite common that people start watching TV and other video content on a PC or portable device, partly due to the success of internet video repositories as YouTube. As a consequence, people are increasingly watching TV and other video content alone, no longer having the possibility to directly comment on what they watch to others.

The advent of social media, and more specifically to social networking services as Facebook, email, mms and Twitter, has made it possible again to some extent to communicate in real time to others about what a user is currently watching. In this way users may exchange messages about the content they are watching and/or listening to. Especially, Twitter has become quite popular to comment in real time on TV programs that are being broadcast.

The existing social networking services are however quite restricted. The messages to be exchanged may include links to webpages, but that does not help to immediately react on unexpected things happening in a TV program. By reacting on a currently broadcast TV program, users have to type in details about the context in order to make it understandable to the recipients of the message. This can be quite distracting, and when being busy with typing in the message, one may miss interesting next events in the TV program. In addition Twitter only allows its users to send short messages of up to 140 characters.

Some newly available services offer solutions that partly alleviate this problem. For example, Yahoo offers a service called IntoNow that can be used on a mobile phone. The mobile phone analyses the sounds that it captures with its microphone to automatically identify which TV program a user is watching, such that a tag with the TV program's name can automatically be included into a tweet that can be sent to friends.

However, this only identifies the TV program and not the specific event or specific scene that the user probably wants to refer to. The assumption is that, when watching TV, a user wants to react to or comment on a specific event or on a specific quote of one of the persons in the TV program.

US2012/0117594 discloses a method of a broadcasting station for providing social broadcasting services. The method comprises the steps:

receiving from a social network server a writing indicator indicating that a message registered using social application by a user of a user equipment is a message regarding broadcasting programs provided by a content provider; and

transmitting both of additional data including the writing indicator and the broadcasting programs to the equipment.

The known method allows a user to share his/her personal opinion and thoughts and the additional data associated with the corresponding programs through the social circle while viewing the broadcasting programs in real time. However, a channel having a wide bandwidth is necessary to transmit both of additional data including the writing indicator and the broadcasting programs to the equipment.

It is an object of the present invention to at least alleviate at least one of the shortcomings presented above.

In accordance with this object a system according to a first aspect of the present invention is provided as claimed in claim 1.

In accordance with this object a method according to a second aspect of the present invention is provided as claimed in claim 10.

In accordance with this object a user equipment according to a third aspect of the present invention is provided as claimed in claim 12.

In accordance with this object a media receiver according to a fourth aspect of the present invention is provided as claimed in claim 13.

In accordance with this object a server according to a fifth aspect of the present invention is provided as claimed in claim 14.

In accordance with this object a computer program product according to a sixth aspect for a user equipment is claimed in claim 15.

In accordance with this object a computer program product according to a seventh aspect for a data processing device is claimed in claim 16.

According to the present invention the internet service is used to transmit the user's message including extracted representative information about a portion of the media item that is reproduced in a time-slot associated with the moment of said request. The wording “associated with” is understood to be the time-slot comprising the point in time of the request or shortly preceding the time of the request, taking into account a certain reaction time of the user, which may vary from a fraction of a second to for example a minute. The representative information can be represented by a relatively limited amount of data as it only represents a particular time-slot of the media item and the information is obtained by extraction. The relevant time-slot may have a duration of a few seconds, e.g. from one second up to 10 seconds. The time-slot may even be the duration of a single frame. Therewith the system is also suitable for use with a social medium that has a relatively small bandwidth, such as Twitter.

In an embodiment the representative information extracted from the media item is text information. Text information is in particular suitable for the latter use, in that it typically requires only a modest amount of data and can be readily combined with user comments. The text information may comprise spoken text, e.g. derived from closed captions or by speech recognition. Alternatively the text information may be derived from other sources, e.g. by recognition of objects or faces appearing in the media-item in the time-slot and subsequently identifying these objects with a description. Extraction of the representative information can take place in various ways.

### BRIEF DESCRIPTION OF THE DRAWINGS

These and other aspects are described in more detail with reference to the drawing. Therein:

FIG. 1 shows an overview of a system according to the first aspect of the invention, comprising a user equipment according to the third aspect of the invention and a media receiver according to the fourth aspect of the invention,

FIG. 2 shows in more detail an embodiment of a user equipment according to the third aspect of the invention and a media receiver according to the fourth aspect of the invention,

FIG. 3 shows in more detail a module of a media receiver according to the fourth aspect of the invention,

FIG. 3a shows in still more detail a component of the module of FIG. 3,

FIG. 4 shows in more detail an alternative embodiment of a user equipment according to the third aspect of the invention,

FIG. 5 shows an overview of an alternative system according to the first aspect of the invention, comprising a user equipment according to the third aspect of the invention a media receiver according to the fourth aspect of the invention, and a server according to the fifth aspect of the invention,

FIG. 5a shows an embodiment of the server of FIG. 5 in more detail,

FIG. 5B shows an overview of another alternative system according to the first aspect of the invention, comprising a user equipment according to the third aspect of the invention a media receiver according to the fourth aspect of the invention, and a server according to the fifth aspect of the invention,

FIG. 6 shows a method according to the second aspect of the invention.

### DETAILED DESCRIPTION OF EMBODIMENTS

Like reference symbols in the various drawings indicate like elements unless otherwise indicated.

In the following detailed description numerous specific details are set forth in order to provide a thorough understanding of the present invention. However, it will be understood by one skilled in the art that the present invention may be practiced without these specific details. In other instances, well known methods, procedures, and components have not been described in detail so as not to obscure aspects of the present invention.

It will be understood that, although the terms first, second, third etc. may be used herein to describe various facilities, elements, components, steps and/or modes, these facilities, elements, components, steps, and/or modes should not be limited by these terms. These terms are only used to distinguish one facility, element, component, step, and/or mode from another element, component, step, and/or mode. Thus, a first facility, element, component, step, and/or mode discussed below could be termed a second facility, element, component, step, and/or mode without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. All publications, patent applications, patents, and other references mentioned herein are incorporated by reference in their entirety. In case of conflict, the present specification, including definitions, will control. In addition, the materials, methods, and examples are illustrative only and not intended to be limiting.

FIG. 1 schematically shows a system 1 comprising a media receiver 10, a rendering device 20 and a user equipment 30. The media receiver 10 is arranged for receiving a broadcast signal BRS comprising media data, such as audio and/ video data. The broadcast signal may be any digital or analog signal comprising the media data. The rendering device 20 provides an audible and/or visual output A/V in response to the broadcast signal BRS. The rendering device 20 may be an integral part of the media receiver 10.

The user equipment 30 is capable of exchanging messages via an internet service 40 using an internet connection 50, to one or more recipients for example via Twitter or Facebook. The user equipment 30 further has a media item comment option for submitting a message MSG about a media item. In an embodiment the user equipment 30 may also allow a user USR1 to control the media receiver 10.

The user equipment 30 is arranged for issuing a data request signal DRQ to the media receiver 10 if the user selects the media item comment option MIC and the media receiver 10 is arranged for extracting representative information about a portion of the media item that is reproduced in a time-slot at the moment of said request, and providing said representative information RINF to the user equipment. The user equipment 30 is capable of including said representative information RINF in said message about a media item. The message MSG is then submitted to user equipment 302 of recipients USR2, via the internet using internet service 40.

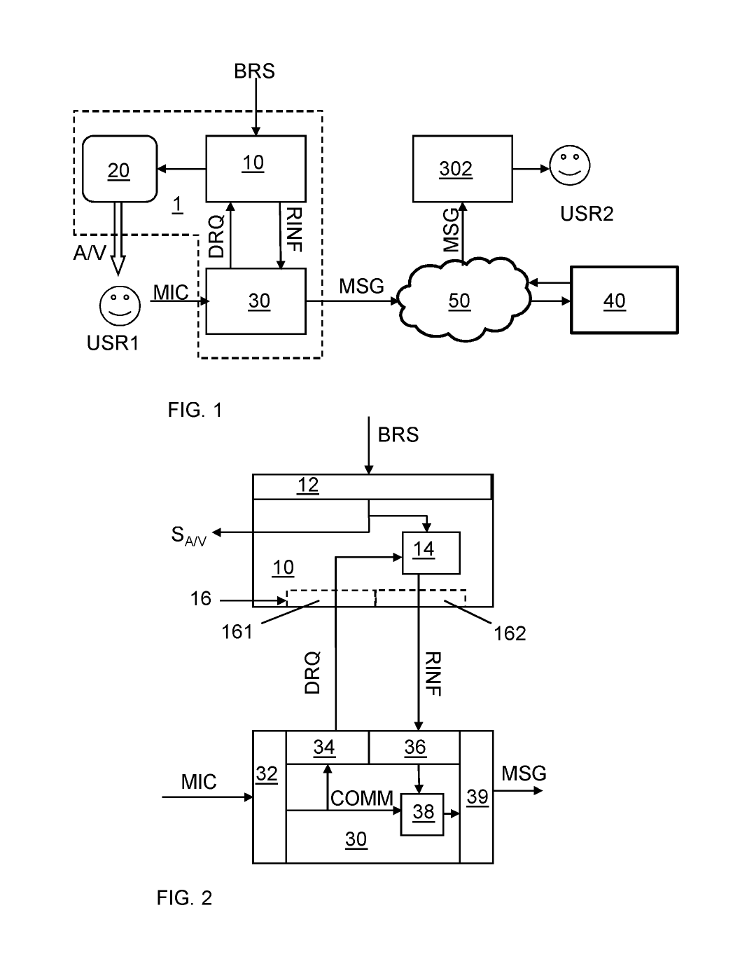

FIG. 2 shows an embodiment of the media receiver 10 and the user equipment 30 in more detail. The user equipment 30 has a user interface 32 allowing the user to select the media item comment option MIC and to provide comments COMM. The user equipment 30 further comprises a transmission module 34 for issuing a data request signal DRQ to the media receiver 10. The request transmission module 34 of the user equipment 30 cooperates with a request reception module 161 of a communication facility 16 of the media receiver. The transmission between request transmission module 34 and request reception module 161 may use any wireless means to transmit the data request signal DRQ for example a Wifi, Bluetooth or an infrared connection which may be used in a higher level protocol as Upnp or DLNA. Alternatively a wired connection may be used, for example if the user equipment 30 and the media receiver 10 are integrated in a shared housing. The user equipment 30 further comprises a response reception module 36 for receiving representative information RINF from a response transmission module 162 of the media receiver 10. Likewise, any wireless or wired connection may be used for this transmission, whatever suits best. The user equipment 30 has a combining module 38 for combining the comments COMM provided by the user with the representative information RINF in said message MSG about a media item. The user equipment 30 has a communication facility formed by an internet access module 39 that subsequently transmits the message MSG including the comment COMM and the representative information RINF via the internet 50 to a respective user equipment 302 of one or more other users USR2 with the internet service 40.

The media receiver 10 comprises a broadcast reception module 12 that is capable of receiving an analog or digital media broadcast signal BRS. The broadcast reception module 12 may comprise a tuner for selecting a particular channel from the signal BRS. The media receiver 10 further comprises a representative information extraction module 14 for extracting representative information RINF about a portion of the media item that is reproduced in a time-slot at the moment of a request DRQ. The representative information RINF extracted by the extraction module 14 is substantially reduced in data content e.g. by at least a factor 100, but preferably by a factor of at least 1000, or even more by a factor of at least 10,000 as compared to the media signal S_{A/V} that is received by the broadcast reception module 12. Various embodiments of an extraction module 14 that enable the required data content reduction are described below.

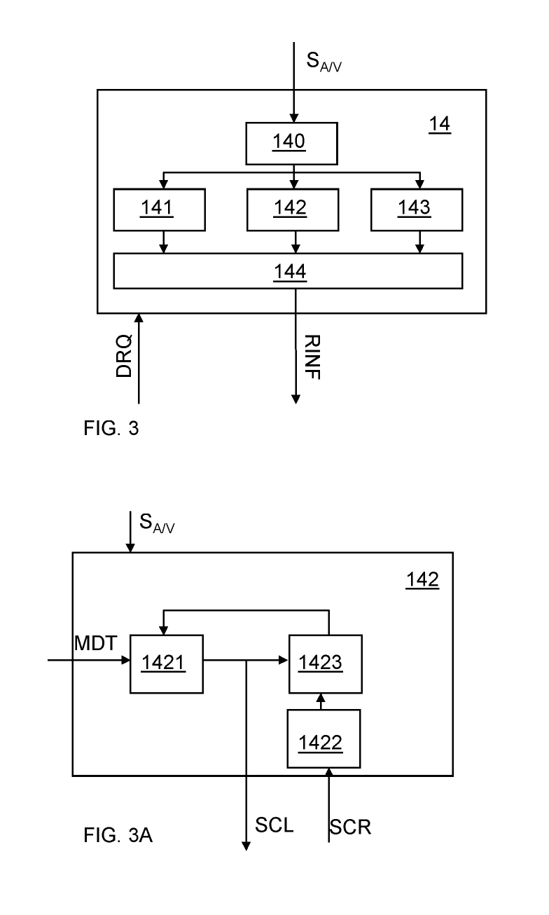

FIG. 3 shows an example of an extraction module 14 in more detail. In the embodiment shown the extraction module 14 comprises a plurality of components that each are capable of extracting particular information from the input signal S_{A/V}. In the embodiment shown the extraction module comprises a first component 141 to extract closed captions from the media signal S_{A/V} representing the media item that the user USR1 is watching. As the data necessary to represent the closed captions is only a fraction of all data in the media signal S_{A/V} the first component 141 achieves a substantial reduction in data amount. The closed captions may be present as a sub-signal in the media signal S_{A/V}. In that case the first component 141 need only separate this sub-signal. Alternatively the first component 141 may comprise an OCR facility to recognize the closed caption data in the image signal. A second component 142 is a speech recognition module. This component 142 can be used as a stand-alone module to recognize spoken text. Alternatively, this component 142 may be used in combination with the first component 141. This combination of components 141, 142 may result in an improved recognition of text present in the media signal S_{A/V}. The second component 142 may in addition be used to discriminate between different speakers. Even if the speakers cannot be identified, this functionality can still be used to indicate that different parts of the recognized text come from different speakers. This information can be visually represented, e.g. by displaying the recognized text with a different color for each speaker. The third component 143 is an image recognition component. This third component 143 may be used for example to recognize faces, e.g. faces of persons appearing in the media item. The information generated by the third component 143 may be combined in a combination module 144 with the information of the second component to 142 to improve recognition. Alternatively or in addition the image recognition component 143 may be used to recognize other features in the media item, e.g. characteristic buildings or scenes. This information in turn may be used to identify a city or a country for example. In the embodiment shown the extraction module 14 comprises a delay component 140 to delay the incoming media signal S_{A/V}. In this way it is taken into account that it will take a certain time before the user reacts to a particular scene. Furthermore, it may be desirable to extract relevant information from a media item in a time-interval before and after the moment of the reaction. In practice an extraction module 14 need not have each of the components 141-143 or may have alternative extraction components, for example a component to extract EPG data from the media signal S_{A/V} or a component to extract representative frames. In some embodiments the extraction module may have a subset of these components, for example only one component, e.g. the first component 141 to extract closed captions from the media signal S_{A/V} representing the media item.

FIG. 3 A shows in more detail the speaker recognition component 142, wherein the speech recognition component 142 has a speaker recognition part 1421 arranged for recognizing the speaker of said spoken language. The speech recognition component 142 further has a correction part 1422 for allowing the user USR1 to correct a speaker recognition result obtained by the speaker recognition part 1421 and having a training part 1423 for training the speaker recognition part 1421 using the correction provided by the user. The speaker recognition part 1421 may use meta-data MDT available in media signal signal S_{A/V} so that the speaker recognition part 1421 only needs to recognize a speaker from a limited set of speakers indicated by the meta-data. During use the speaker recognition part 1421 generates a signal SCL indicative for the speaker it recognized. If necessary, the user can correct this recognition result, for example by typing or speaking the corrected name or by pointing to the correct name in a list of names, for example the list of names available in the meta data MDT. The feedback given by the user in this way is indicated as the signal SCR. Alternatively, the user may give feed back SCR by merely approving or disapproving the classification result SCL. Using the feedback by the user, the training part 1423 trains the recognition part 1421 to improve the recognition result.

Likewise the image recognition module 143, may have a correction part for allowing the user USR1 to correct a face recognition result obtained by a face recognition component and a training part for training the face recognition component using the correction provided by the user.

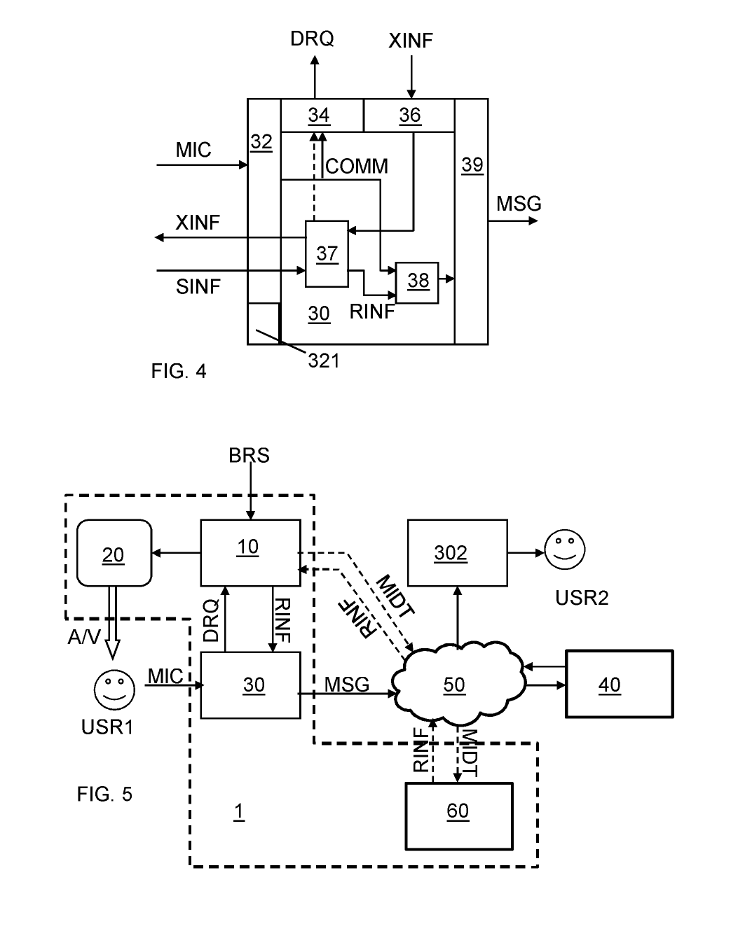

FIG. 4 shows an alternative embodiment of the user equipment 30. This embodiment is also suitable for use with a media receiver that is arranged for providing said representative information RINF as part of more extensive representative information XINF. To that end the user equipment 30 has a facility 37 that enables the user to select said representative information RINF from said more extensive representative information XINF, by specifying a selection SINF. The more extensive representative information XINF may for example comprise an overview of text uttered in the media item in the time-slot at the moment of the request DRQ, and the facility 37 enables the user USR1 to make a selection from the text in this overview. Typically the facility 37 would present a plurality of text items in a single overview. The facility 37 may present this more extensive representative information XINF with the user interface 32 of the user equipment 30. Alternatively however, facilities of the receiver 10 and the rendering device 20 may be used to display the more extensive representative information XINF. In the latter case, typically a larger screen is available for display of the information XINF. The text uttered may be visually clustered into respective clusters for each scene. The text may be colored with a different color for each speaker. The user USR1 may subsequently select the representative information, for example by selecting a cluster of text or selecting a sentence. The selection SFNF may be specified by any known means, for example by pointing at a sentence or a cluster of sentences, typing a number if the sentences are numbered, speaking a keyword unique for one of the sentences. To that end the user interface 32 may have a speech recognition module 321.

As another example, the more extensive representative information XINF provided by the extraction unit 14 may be a list of persons appearing in a time-window including the moment of selection of the media comment option. The user may select one or more items from that list to be included as the representative information RINF in the message MSG.

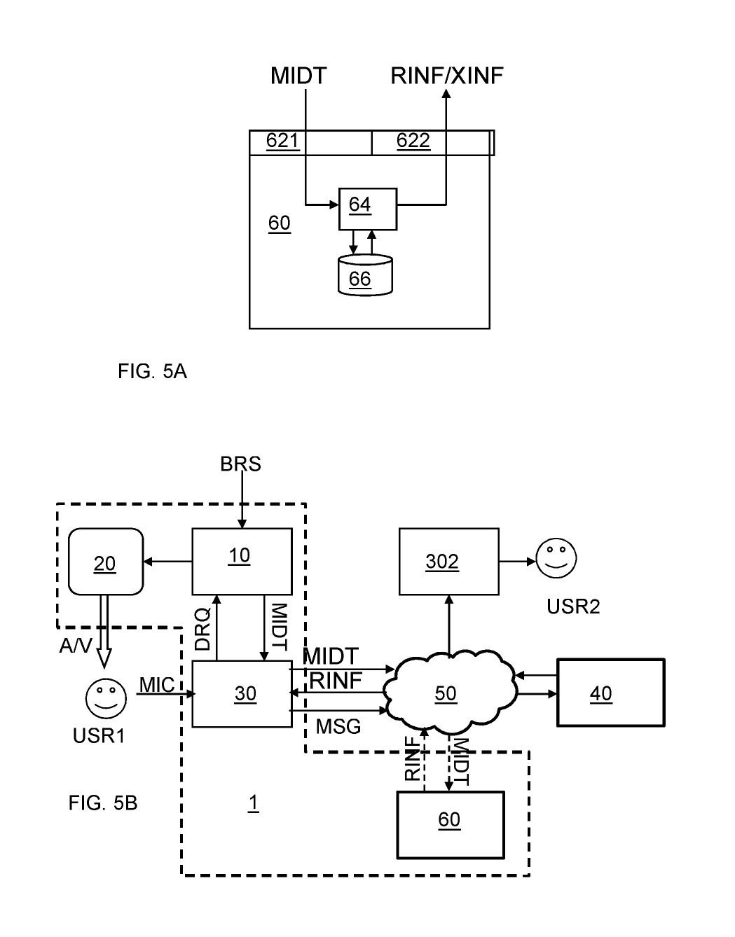

FIG. 5 shows an alternative arrangement. In this arrangement the media receiver 10 is coupled to a server 60, here via internet connection 50. In this arrangement the media receiver 10 is a requestor that request the representative information about the media item from the server 60. To that end, upon activation of the media item comment option, the system is arranged for submitting to the server 60 an indication MIDT. The indication MIDT indicates the media item that is reproduced at the moment of said activation, and also includes a time-indication that indicates which portion of said media item is reproduced at the moment of said activation. The indication of the media item is available for example from the EPG, and time stamp information in the video signal can be used as a time-indication for example. The indication MIDT may be transmitted in accordance with a standard known as such, e.g. the TV Anytime Standard, or as a proprietary ID, e.g. UUID (Universally Unique Identifier) In response to the indication MIDT, the server 60 is arranged for providing the media receiver with said representative information RINF to be included in said message MSG about said media item. Optionally said representative information RINF is provided as part of more extensive information XINF. The media receiver 10 then provides this information RINF to the user equipment 30. In an alternative embodiment described in more detail with reference to FIG. 5B, the user equipment 30 transmits the indication MIDT and in return receives the representative information RINF from the server 60.

FIG. 5A shows the server 60 in more detail. The server comprises an input facility 621 for receiving from a requestor, here the media receiver 10, the indication MIDT. The server 60 further comprises a storage facility 66 for storing media information. The media information may comprise content information of the media items, but may alternatively or in addition comprise meta-date about the media items. The server 60 further comprises a data extraction facility 64 for extracting representative information RINF about the temporary portion of said media item from said media information stored in the storage facility 66. The data extraction facility 64 may comprise similar modules as the modules described for the data extraction facility 14 of the media receiver 10 with respect to FIG. 3. The server further comprises an output facility 622 for transmitting the representative information RINF to the requestor. Likewise the server 60 may be capable of providing said representative information RINF as part of more extensive representative information XINF. In that case the user USR can select the representative information RINF from the more extensive representative information XINF in a way analogous as described with reference to FIG. 4.

FIG. 5B shows an overview of another alternative system according to the first aspect of the invention, comprising a user equipment according to the third aspect of the invention a media receiver according to the fourth aspect of the invention, and a server according to the fifth aspect of the invention. In the arrangement of FIG. 5B, the user equipment 30 is the requestor. Upon activation of said media item comment option in this alternative system, the user equipment 30 is arranged for receiving from the media receiver 10 the indication MIDT, and for submitting this indication to the server 60, here via internet connection 50. The server 60 is arranged for providing to said user equipment 30 said extracted representative information RINF to be included in said message MSG about said media item.

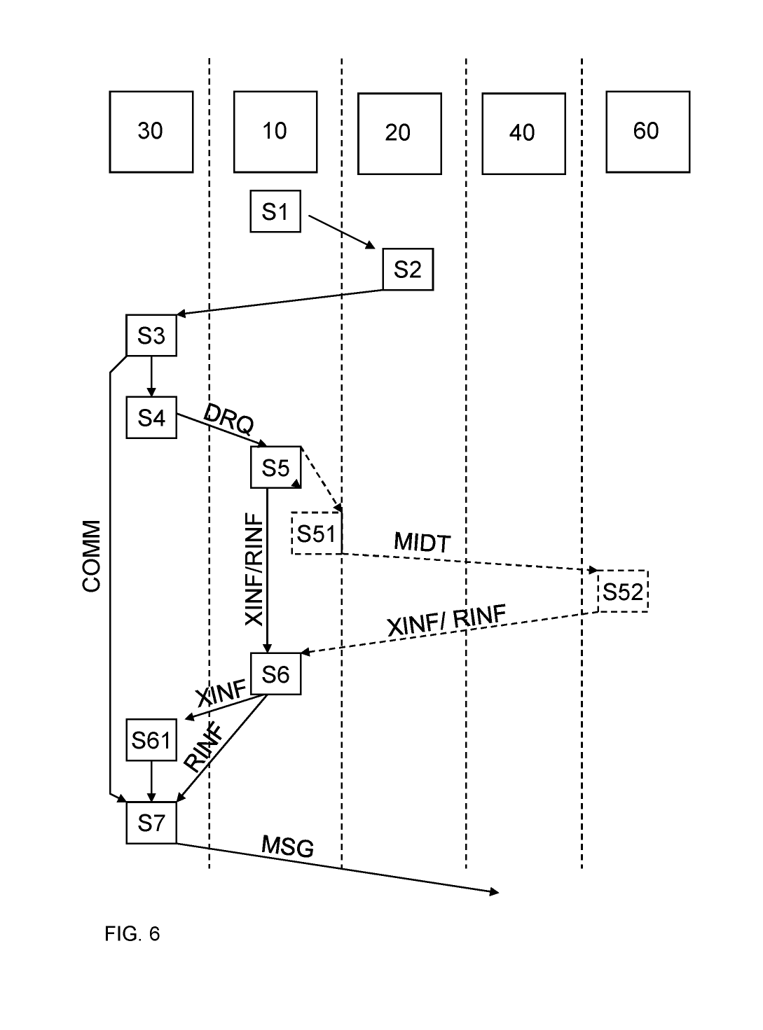

FIG. 6 schematically shows a method according to the second aspect of the invention. The method as shown in FIG. 6 comprises the following steps. In a first step S1 a media receiver 10 receives a broadcast signal BRS comprising media data. In a second step S2 this media data is used by a rendering device 20 for rendering an audible and/or visual output in response to the broadcast signal. The rendering device 20 may be integrated with the media receiver 10. Alternatively, the media receiver 10 may be a separate device, e.g. a set-top box. The user perceiving the audible and/or visual output is capable of controlling the media receiver 10 with a user equipment 30. This may be for example a remote control, a tablet or a smart-phone. In an embodiment the user equipment 30 may be an integral part of the media receiver 10. In another embodiment the user equipment 30 may also function as the rendering device 20. In again another embodiment a single device (e.g. a suitably programmed personal computer, laptop or tablet etc) performs the functions of the media receiver 10, the rendering device 20 and the user equipment 30. The user equipment 30 has a media item comment option. By selection of this option in step S3, the user is enabled to submitting a message MSG about a media item via an internet service 40, such as Twitter or Facebook. Upon selection S3 of the media item comment option, a data request signal DRQ is issued in step S4 to the media receiver 10. In case the user equipment 30 and the media receiver 10 are separate components, this data request signal DRQ will typically be transmitted wirelessly, e.g. via a Bluetooth connection. In case the user equipment 30 and the media receiver 10 are integrated, a wired connection may be more suitable for this transmission. Upon receipt of the signal DRQ, representative information RINF about a portion of the media is extracted in step S5 and submitted S6 to the user equipment 30. This extraction S5 may be carried out by the media receiver 10, but may alternatively be carried out by a remote server 60 as indicated by dotted lines in FIG. 6. In the latter case the media receiver 10 is arranged for submitting in step S51 to said server 60 an indication MIDT of a media item that is reproduced at the moment of said activation, as well as a time indication that indicates which portion of said media item that is reproduced at the moment of said activation. Using this information the server 60 generates the representative information RINF and transmits this information in step S52 to the media receiver 10. In step S6 the representative information RINF is provided to the user equipment 30. Subsequently, in step S7, the user equipment 30 includes the representative information RINF in the message MSG, so that the message comprises both the comments COMM of the user and the representative information RINF.

It is alternatively possible that the media receiver provides the representative information RINF as part of more extensive representative information XINF. In that case the user is enabled to select in an optional step S61 said representative information RINF from said more extensive representative information XINF. Also in this case, the media receiver 30 may retrieve the information XINF from an external server 60.

In again another embodiment the media receiver 10 provides the user equipment 30 in response to said data request signal DRQ an indication MIDT of a media item that is reproduced at the moment of said activation, as well as a time indication that indicates which portion of said media item that is reproduced at the moment of said activation. The user equipment 30 can use this indication MIDT, to request representative information RINF from the server 60.

A ‘facility’, as will be apparent to a person skilled in the art, is meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In device claims enumerating several facilities, several of these facilities can be embodied by one and the same item of hardware. ‘Computer program product’ is to be understood to mean any software product stored on a computer-readable medium, such as a floppy disk, downloadable via a network, such as the Internet, or marketable in any other manner.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). Also, use of the “a” or “an” are employed to describe elements and components of the invention. This is done merely for convenience and to give a general sense of the invention. This description should be read to include one or at least one and the singular also includes the plural unless it is obvious that it is meant otherwise.

In another embodiment, the system further comprising a face recognition module (143), arranged for recognizing a an object or a person from image data present in the media-item, and for including an identification of the object or person as text information representative for the media item.

In a further embodiment, the system further comprises a the data extraction facility (14) is part of the media receiver (10), wherein the user equipment (30) is arranged for issuing the data request signal (DRQ) to the media receiver (10) and wherein the media receiver (10) is arranged for providing said extracted representative information (RINF) to be included in said message (MSG) about said media item.

In another embodiment, the system further comprises a server (60), and a requestor (10; 30), said server (60) comprising the data extraction facility (14), wherein upon activation of said media item comment option, the requestor (10; 30) is arranged for submitting to said server an indication (MIDT) of a media item that is reproduced at the moment of said activation and of a portion of said media item associated with the moment of said activation, and wherein the server (60) is arranged for providing said requestor with said extracted representative information (RINF) to be included in said message (MSG) about said media item.

In another embodiment of the system, the media receiver (10) is the requestor.

In another embodiment of the system, the user equipment (30) is the requestor, wherein upon activation of said media item comment option, the user equipment (30) is arranged for receiving from the media receiver (10) the indication (MIDT), and for submitting this indication to the server and wherein the server (60) is arranged for providing to said user equipment (30) said extracted representative information (RINF) to be included in said message (MSG) about said media item.

In another embodiment of the system, the representative information (RINF) extracted from the media item is text information.

In another embodiment of the computer program product comprises instructions for causing a data processing device to carry out the steps of
receiving a data request signal (DRQ) from a user equipment,
extracting representative information (RINF) about a portion of a media item that is reproduced in a time-slot associated with the moment of said data request signal, and
providing said representative information (RINF) to the user equipment.

1. A systems, comprising:
a media receiver for receiving a broadcast signal comprising media data;
a rendering device for providing an audible and/or visual output from the media data;
a user equipment capable of exchanging messages via an internet service, the user equipment having a media item comment option for submitting a message about a media item;
a data extraction facility for providing extracted representative information about a portion of the media item, such that upon selection by the user of the media item comment option, the system has an operational state, wherein the user equipment issues a data request signal the data extraction facility provides representative information about a portion of the media item that is reproduced in a time-slot associated with the moment of said request from the user equipment; the user equipment includes the representative information in the message about the media item.

2. The system according to claim 1, wherein the representative information extracted from the media item is text information.

3. The system according to claim 1, wherein the data extraction facility is arranged for providing said representative information as part of more extensive representative information and that the user equipment has a facility that enables the user to select said representative information from said more extensive representative information.

4. The system according to claim 3, wherein said more extensive information includes an overview of text uttered in said media item in said time-slot, and wherein the facility enables the user to make a selection from the text in this overview.

5. The system according to claim 2, wherein the text information is obtained from closed captions in the media item.

6. The system according to claim 2, wherein the data extraction facility has a component for deriving the text information by speech recognition from spoken language in the media item.

7. The system according to claim 6, wherein the component has a speaker recognition part arranged for recognizing the speaker of the spoken language, and for including an identification of the speaker as text information representative for the media item.

8. A method comprising
receiving by a media receiver, a broadcast signal comprising media data,
rendering an audible and/or visual output in response to the broadcast signal,
selecting a media item comment option for submitting a message about a media item via an internet service,
issuing a data request signal to the media receiver;
extracting representative information about a portion of the media item that is reproduced in a time-slot associated with the moment of said data request signal;
providing the representative information to the user equipment, and
including the representative information in the message.

9. The method according to claim 8, wherein the representative information is provided as part of more extensive representative information and wherein the user is enabled to select the representative information from the more extensive representative information.

10. A user equipment comprising:
a first communication facility for exchanging messages via an internet service, the first communication facility having a media item comment option for submitting a message with user comments about a media item;
an extracted information reception module for receiving extracted representative information about a portion of said media item;
a second communication facility having a request transmission module and a response reception module; and
a combination facility, upon selection of the media item comment option the user equipment having an operational state wherein:
the request transmission module of the second communication facility transmits a media extract request signal to a media receiver,
the response reception module of the second communication facility receives a response to the media extract request signal from the media receiver related to a portion of the media item that is reproduced by the media receiving facility in a time-slot associated with the moment the extract request signal is received,
the extracted information reception module receives extracted representative information about the portion of the media item,
the combination facility combines the extracted representative information with the message,
the first communication facility transmits the message including the extracted representative information via the internet service.

11. The user equipment according to claim 10, wherein the response reception module of the second communication facility is arranged to receive as the response from the media receiver the extracted representative information about the portion of the media item.

12. The user equipment according to claim 10, wherein the response reception module of the second communication facility is arranged to receive as the response from the media receiver an indication indicative of a media item that is reproduced at the moment of the activation and of a portion of the media item associated with the moment of activation of the media comment option, wherein the first communication facility is arranged to transmit the indication to a server, wherein the extracted information reception module is part of the first communication facility, the extracted information reception module being arranged to receive from the server the extracted representative information about the portion of the media item.

13. A media receiver, comprising:
a receiving facility for receiving a broadcast signal comprising media data to be reproduced;
a communication facility for communicating with a user equipment for controlling the media receiver, the communication facility having a request reception module and a response transmission module; and
a data extraction facility for extracting representative information about a portion of a media item, the media receiver having an operational state wherein:
the request reception module of the communication facility receives a media extract request signal;
the data extraction facility extracts representative information about a portion of the media item that is reproduced in a time-slot associated with the moment the media extract request signal is received; and
the response transmission module of the communication facility transmits the extracted representative information to the user equipment.

14. A server, comprising:
an input facility;
a storage facility for storing media information;
a data extraction facility for extracting representative information about a temporary portion of a media item from the media information stored in the storage facility;
an output facility for transmitting the representative information the server having an operational state wherein;
the input facility receives from a requestor an indication of a media item and a time indication that indicates a temporary portion of the media item;
the data extraction facility extracts the representative information about the temporary portion of the media item according to the indications received from the requestor; and
the output facility transmits the representative information to the requestor.

15. A non-transitory tangible computer medium comprising instructions for causing a user equipment to carry out the following:
selecting a media item comment option for submitting a message including comments about a media item via an internet service, further comprising instructions for causing the user equipment to carry out;
upon selecting the media item comment option, issuing a data request signal to a media receiver or an indication to a server, indicative of a media item that is reproduced at the moment of the selection and of a portion of the media item associated with the moment of activation of the media comment option,
receiving from the media receiver or the server representative information about a portion of the media item that is reproduced in a time-slot associated with the moment of the data request signal,
including the representative information in the message.
